(19) United States
(12) Patent Application Publication
(10) Pub. No.: US 2004/0211047 A1
(43) Pub. Date: Oct. 28, 2004

(54) Socket life-extending driving tool

(76) Inventors: Robert W. Moushon, Bossier City, LA (US); Gaylan W. Moushon, Calimesa, CA (US)

Correspondence Address: STEVEN J. ADAMSON, PC, P.O. BOX 5997, PORTLAND, OR, 97228, US

(21) Appl. No.: 10/665,983

(22) Filed: Sep. 19, 2003

Related U.S. Application Data
(60) Provisional application No. 60/412,384, filed on Sep. 20, 2002.

(51) Int. Cl. B25B 27/00

(52) U.S. Cl. 29/270

(57) ABSTRACT

A seal driving tool for use with sockets or like devices that are used to position seals. The driving tool may have multiple segments including a force receiving member, an extender and an adapter. All, some or one of these items may be used in accordance with the present invention. The seal driving tool affords extended socket life and flexibility of use situations to the user.

### CROSS REFERENCE TO RELATED APPLICATIONS

This application claims the benefit of U.S. Provisional Application No. 60/412,384, filed Sep. 20, 2002, and having the same title and inventor(s) as above.

### FIELD OF THE INVENTION

The present invention relates to seal drivers and, more specifically, to reducing damage to sockets that are mis-used as seal drivers.

### BACKGROUND OF THE INVENTION

Many machines have a spinning or sliding shaft about which seals are provided. Seals typically include a rigid, metal ring or disc interior of which is mounted a flexible rubber or other suitable material. Seals are often used to prevent or reduce lubricant leakage and prevent the accumulation of dust and dirt around ball-bearings or other devices that provide low-friction support to a shaft. Other seal arrangements are also known in the art.

Seal drivers have been developed to mount seals into position for subsequent insertion of a shaft into the seal. Typically these drivers consist of a set of sturdy discs or like members that are coupled to a driving member. In use, a disc is placed adjacent a seal and the driving member is struck, creating a force that transfers through the driving member to the disc and then the seal, driving the seal into position.

A disadvantageous aspect of current seal driver sets is that they are very expensive, based in part on the specialized nature of the device. Due to their significant expense, many individual mechanics typically do not have a set of seal drivers and larger shops tend to have one set to be shared by several mechanics, leading to situations in which a desired seal driver size is not available.

A less expensive alternative to a set of seal drivers is a socket set—a standard accessory for most mechanics. Use of a socket is also advantageous because their hollow cylindrical structure permits driving of a seal onto a shaft, whereas the flat discs described above do not. When using a socket as a seal driver, a mechanic selects the socket size that approximates the size of a given seal and drives that seal into position by striking on the socket. This use, which is illustrated in FIG. 1, constitutes “mis-use” of the socket 16 and often damages the socket resulting in significantly shorted product life. Notwithstanding damage to the sockets, it is standard practice in many shops to drive seals 18 with sockets.

This practice is in part exacerbated by tool companies that offer life-time tool warranties that allow mechanics to simply replace the damaged sockets at no charge to the mechanic. This results in financial loss to the tool maker and unnecessary and undesirable resource consumption to generate new sockets.

### SUMMARY OF THE INVENTION

Given the propensity of mechanics to use sockets to drive seals, it is an object of the present invention to provide a device for driving seals with sockets in a manner that significantly reduces damage to the sockets and thus extends their useful life.

It is another object of the present invention to provide such a device that accommodates sockets of various sizes.

It is also an object of the present invention to provide such a device that has an extender mechanism for driving seals located at a distance from the seal driver striking surface.

These and related objects of the present invention are achieved by use of a socket life-extending driving tool as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIG. 1 is a diagram of a hammer striking a socket used to drive a seal.

FIG. 2 is a diagram of a socket driving device in accordance with the present invention.

FIG. 3 is a perspective view of the device of FIG. 3, excluding the extender, in accordance with the present invention.

FIGS. 4A-4B are an end view and a side view of a driving shaft in accordance with the present invention.

FIGS. 5A-5C are an end view, a side view and the other end view of an adapter in accordance with the present invention.

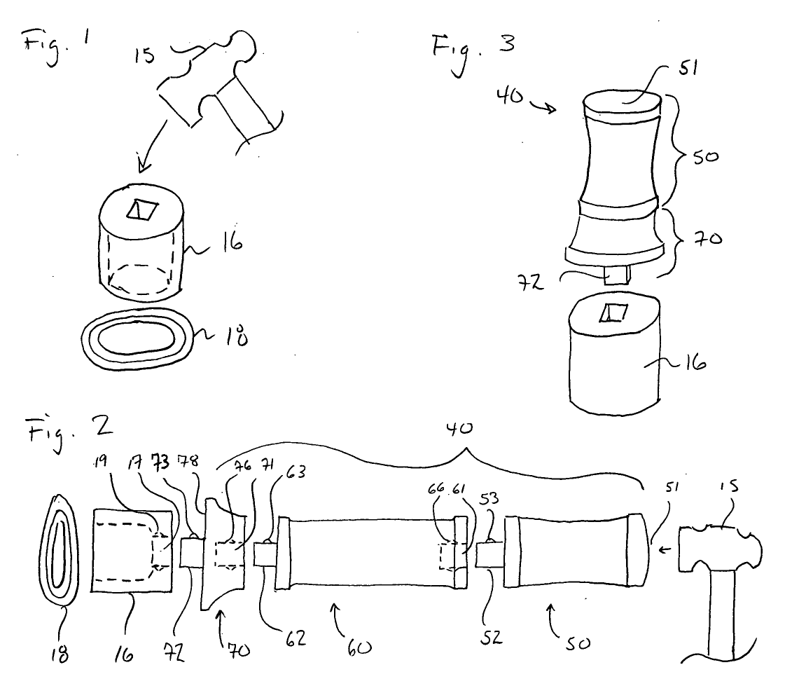

### DETAILED DESCRIPTION

Referring to FIG. 2, a diagram of a socket driving device 40 in accordance with the present invention is shown. The socket driving device 40 includes a driving shaft 50, an extender 60 and an adapter 70. In use, a socket 16 is mounted to adapter 70 and aligned with seal 18. A hammer 15 delivers a driving force through driving shaft 50 that translates through driving device 40 onto socket 16 and seal 18.

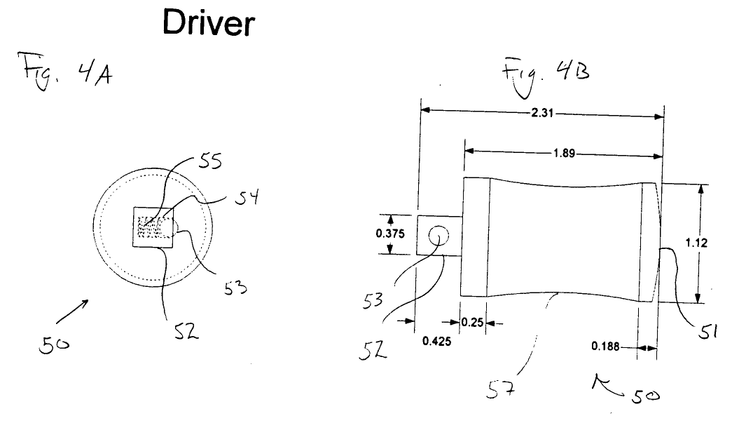

Driving shaft 50 is preferably formed of a solid or similarly rigid structure and includes a striking surface 51 on one end and a coupling protrusion 52 on the other end. The striking surface is configured to withstand repeated hammer strikes. Driving shaft 50 is preferably circular in lateral cross-section to distribute driving force, though other cross-sectional shapes may be used without departing from the present invention. The driving shaft may be coupled through extender 60 to adapter 70 or directly to adapter 70 (as shown in FIG. 3) or directly to a socket 16.

Extender 60 preferably has a lateral cross-sectional shape that is similar to that of the driving shaft. The extender includes a recess 61 for receiving coupling protrusion 52 and a coupling protrusion 62 for coupling into adapter recess 71. Coupling protrusion 52 preferably includes a biased ball bearing 53 or the like that positively engages coupling notch 66. Similarly, coupling protrusion 62 preferably includes a biased ball bearing 63 or the like that positively engages coupling notch 76. Note that the extender may be provided in various lengths.

Adapter 70 includes a coupling protrusion 72, which may be the same or different size as that of the driving shaft or extender. Adapter 70 may have a cylindrical, conical, fluted or other shape. A fluted configuration is shown in FIG. 2. The fluted, conical or like shape serves to distribute driving force across socket coupling surface 78, resulting in more uniform application of force onto socket 16. Coupling protrusion 72 preferably includes a biased ball bearing 73 or the like that positively engages coupling notch 19 of socket recess 17.

While the driving shaft, extender and adapter are shown in a linear, inner-connected arrangement in FIG. 2, it should be recognized that the present invention may be practiced with less than all three components. As noted above, the driving shaft may be coupled directly to socket 16 or to adapter 70. In addition, the driving shaft and extender may be coupled directly to a socket, i.e., without adapter 70.

It should also be recognized that the coupling protrusions of the driving shaft and the adapter may be differently sized. For example, the coupling protrusion 52 of the driving shaft 50 may be ⅜″ square while the coupling protrusion of the adapter may be ½″ square. This enables device 40 to accommodate a greater range of socket sizes. It may also serve to better distribute driving force from the driving shaft to larger sized sockets. It should also be recognized that a plurality of different size adapter could be provided to accommodate different size sockets.

The driving shaft, extender and adapter are preferably made of hardened steel or other material that is standard is socket manufacture. Alternatively or in combination, parts of the driving shaft, extender and/or adapter may be made of a hard plastic or resin or other material as are the handles of some wood chisels and the like.

Referring to FIG. 3, a perspective view of device 40, excluding extender 60, is shown in accordance with the present invention. In use, socket 16 would be mounted on the coupling protrusion 72 of adapter 70, and a hammer would strike striking surface 51, thereby transferring a driving force to a seal aligned with the socket.

Referring to FIGS. 4A-4B, an end view and a side view of driving shaft 50 in accordance with the present invention are respectively shown. The end view illustrates a ball bearing 53 resident in groove 54 in protrusion 52. The ball bearing is biased by spring 55 and when inserted into an extender, adapter or socket engages coupling notch 66, 76 or 19 in that part.

Side view, FIG. 4B, illustrates the position of ball bearing 53 in protrusion 52 and the opposing arrangement of striking surface 51 and protrusion 52. Holding section 57 is provided between the striking surface and the protrusion. Holding section 57 includes a tapered depression for ease of holding during use. Other configurations and/or the use of a rubber “no-slip” grip of the like could also be provided in this section.

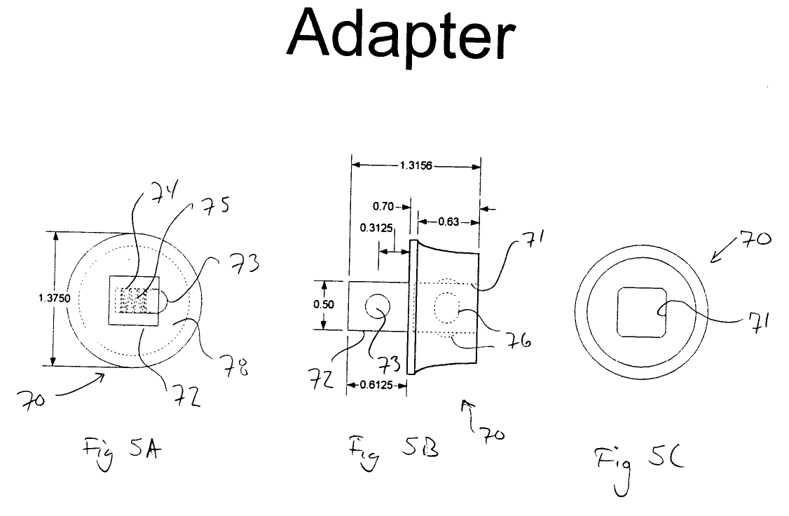

Referring to FIGS. 5A-5C, an end view, side view and other end view of adapter 70 in accordance with the present invention are respectively shown. FIG. 5A illustrates the socket coupling surface 78 and protrusion 72 that includes a ball bearing 73, groove 74 and spring 75 as discussed above for driving shaft 50 (extender protrusion 62 includes similar components).

Side view, FIG. 5B, illustrates the arrangement of protrusion 72, recess 71 and the remainder of the adapter body. The other end view illustrates the location of recess 71, amongst other features.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A socket driving device, comprising:
a longitudinally arranged driving shaft formed of a durable, rigid material and configured to have a striking surface on one end and a first coupling protrusion on another end;
said first coupling protrusion being configured for releasable positively-engaged coupling to a complementary configured recess.

2. The device of claim 1, further comprising:
an adapter having a driving shaft coupling end and a socket coupling end;
said adapter having a coupling recess formed on said driving shaft coupling end and a second coupling protrusion formed on said socket coupling end.

3. The device of claim 2, further comprising:
an extender having a driving shaft coupling end and a socket coupling end;
said extender having a coupling recess formed on said driving shaft coupling end and a coupling protrusion formed on said socket coupling end.

4. The device of claim 2, wherein the surface area of said driving shaft coupling end and the surface area of said socket coupling end are different in size.

5. The device of claim 2, wherein the said first coupling protrusion and said second coupling protrusion have different sized lateral cross-sectional areas.

6. The device of claim 3, wherein said extender is configured for releasable coupling between said driving shaft and said adapter to extend the distance of said adapter from said driving shaft.

7. The device of claim 1, further comprising a socket mounting surface provide about said first coupling protrusion and configured to facilitate delivery of a substantially uniform drive force to a socket.

8. The device of claim 1, wherein said first protrusion includes a biased member that facilitates said releasable coupling.

9. A socket driving device for driving a socket used in seal mounting or other purposes, comprising:
a socket driving member configured to be held by a human hand when in use and including a striking surface, a socket mounting surface and a socket engaging mechanism;
said striking surface being formed of a metallic material and configured to withstand a driving blow;
said socket mounting surface being provided substantially opposite said striking surface and being substantially planar and radially disposed so as to provide a substantially uniform drive force to a socket being driven by said device; and
said socket engaging mechanism including a socket coupling protrusion configured for releasable coupling to a socket.

10. The device of claim 9, wherein said protrusion extends from said mounting surface and includes a biased member that facilitates releasable coupling to a socket.

11. The device of claim 9, wherein said socket driving member includes a first section and a second section, said first section including said striking surface and said second section including said mounting surface and said socket engaging mechanism, said first and second sections being releasably couplable to one another.

12. The device of claim 11, wherein said first section includes a first section protrusion and said second section includes a complementary coupling recess, wherein said first section protrusion is configured for coupling to at least one of said second section and a socket.

13. The device of claim 12, wherein said first section protrusion and said socket coupling protrusion have different lateral cross-sectional areas to accommodate different sized sockets.

14. The device of claim 9, wherein said socket driving member includes a first section, a second section and a third section, said first section including said striking surface, said second section including said mounting surface and socket engaging mechanism, and said third section being removably coupled between said first and second sections to extend the distance from said striking surface to said mounting surface and socket engaging mechanism.

15. The device of claim 11, wherein the surface area of said mounting surface is greater than the lateral cross-sectional surface area of said first section.

16. A socket driving device for driving a socket used in seal mounting or other purposes, comprising:
a socket driving member configured to be held by a human hand when in use and including a striking surface, a socket mounting surface and a socket engaging mechanism;
said striking surface being formed of a rigid, durable material and configured to withstand a driving blow;
said socket mounting surface being provided substantially opposite said striking surface and being disposed so as to provide a substantially uniform drive force to a socket being driven by said device; and
said socket engaging mechanism configured for releasable coupling to a socket.

17. The device of claim 16, wherein said socket engaging mechanism includes a first coupling protrusion configured for releasable coupling to a socket.

18. The device of claim 16, wherein said socket driving member includes a first section and a second section, said first section including said striking surface and said second section including said mounting surface and said socket engaging mechanism, said first and second sections being releasably couplable to one another.

19. The device of claim 18, wherein said socket engaging mechanism includes a first releasable coupling protrusion and said first section includes a second releasable coupling protrusion, and the lateral cross-sectional areas of said first and second releasable coupling protrusions are different to accommodate different sized sockets.

20. The device of claim 18, further comprising a third section releasably couplable between said first and second sections to extend the distance from said first section to said second section.
